(19) United States
(12) Patent Application Publication
(10) Pub. No.: US 2008/0071776 A1
(43) Pub. Date: Mar. 20, 2008

(54) Information retrieval method in mobile environment and clustering method and information retrieval system using personal search history

(75) Inventors: Jeong-mi Cho, Suwon-si (KR); Byung-kwan Kwak, Yongin-si (KR); Jeong-su Kim, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/882,332

(22) Filed: Jul. 31, 2007

(30) Foreign Application Priority Data
Sep. 14, 2006 (KR) 10-2006-0089159

(51) Int. Cl. G06F 17/30

(52) U.S. Cl. 707/5; 707/E17.108

(57) ABSTRACT

A mobile information retrieval method, clustering method, and an information retrieval system using a user's search history. The mobile information retrieval method includes receiving the user's query information and retrieving information related to the query information through predetermined networks in a database in which history information generated by previous retrieval is stored. The mobile information retrieval method, clustering method, and information retrieval system can relieve inconvenience of information retrieval caused by limits in terms of a display screen, battery capacity and computing resources, and can curtail charges for Internet use and data downloads.

### CROSS-REFERENCE TO RELATED APPLICATIONS

This application claims the benefit of Korean Patent Application No. 10-2006-0089159, filed on Sep. 14, 2006, in the Korean Intellectual Property Office, the disclosure of which is incorporated herein in its entirety by reference.

### BACKGROUND OF THE INVENTION

1. Field of the Invention

The present invention relates to an information retrieval method in a mobile environment, clustering method and information retrieval system using personal search history. More particularly, to an information retrieval method in a mobile environment, clustering method and information retrieval system where query information or link information used in retrieving content is stored in a mobile terminal together with the content and re-used for information retrieval and clustering.

2. Description of the Related Art

As mobile Internet becomes more widely used, searching the web and downloading content onto mobile terminals is becoming more common. Conventionally, for information retrieval in a mobile environment, users access web sites whenever they need to search the web, which is the same as an information retrieval method using a personal computer (PC).

PCs have convenient information input means such as a keyboard and provide high searching and fast downloading speeds. In addition, charges for Internet use and data are relatively inexpensive for PCs. Thus, logging onto and searching the web whenever necessary is not inconvenient when using a PC. However, using a mobile terminal is limited in terms of display screen size, battery power source, and charges for Internet use and data downloads compared to using a PC.

U.S. Pat. No. 6,256,633 discloses a web information retrieval method which sets fields of a user's interest through direct or indirect feedback, provides the fields that are relevant to the user's interest after filtering when the user request information retrieval (see FIG. 1). This reference discloses an information retrieval method which provides each user with web search results (30) after filtering based on each user's fields of interest (20) when user A and user B have different fields of interests and the same keywords such as “processor micro” are entered by the users (10).

U.S. Pat. No. 6,564,222 discloses a web retrieval method which uses information regarding a user's application and query, as a context with appropriate search engines (see FIG. 2). U.S. Pat. No. 6,611,834 discloses an information retrieval method, in which an executable code input by a user is sent to a database server, and is used as middleware to communicate between the database and a client for customizing various processes of the database retrieval session.

U.S. Patent Publication No. 2005/0203884 discloses a method in which a user personally constructs hierarchical interest profiles and the user's filter vector, thereby retrieved content is filtered and provided to the user. As shown in FIG. 3, when “Utah” is input as a query for example, results of web search are filtered according to preset content classification and provided to a user.

The above-mentioned methods aim at improving the efficiency of Internet information retrieval using PCs and require access to Internet for retrieving information and are used for general-use computers which are not limited in terms of accessing Internet.

However, mobile terminals are limited, for example, in terms of size of display screen, battery capacity, computing resource, charges for Internet use and data downloads. Therefore, information retrieval methods which require accessing Internet are inefficient for use in mobile terminals.

### SUMMARY OF THE INVENTION

Accordingly, it is an aspect of the present invention to provide a mobile information retrieval method, clustering method, and information retrieval system, which can relieve inconvenience of information retrieval in a mobile environment owing to limited display screen, battery capacity, and computing resources, and curtail charges for internet access and data download. In addition, an aspect of the present invention provides a computer-readable medium on which programs for operating the information retrieval and clustering method are recorded.

Additional aspects and/or advantages of the invention will be set forth in part in the description which follows and, in part, will be apparent from the description, or may be learned by practice of the invention.

The foregoing and/or other aspects of the present invention are achieved by providing a mobile information retrieval method including receiving a user's query information, and retrieving information related to the received query information from a database in which history information generated by previous retrieval using a predetermined networks is stored.

It is another aspect of the present invention to provide a content information clustering method including extracting information related to retrieval of at least one content information that is retrieved through a predetermined network, and clustering the content information using the extracted information.

It is another aspect of the present invention to provide a computer readable medium implementing the mobile information retrieval method or the content information clustering by a computer.

It is another aspect of the present invention to provide a mobile information retrieval system including a history information storage unit which stores history information including information generated by previous information retrieval through predetermined networks, an input unit which receives a user's query information, a control unit which retrieves information related to the query information in the history information storage unit, and selectively accesses the predetermined networks to retrieve information related to the query information, and an output unit which provides the information retrieved by the control unit.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating a conventional information retrieval method which filters and provides search results that are relevant to fields of interest of a user;

FIG. 2 is a table illustrating database of context using applications and queries for selecting search engines according to a conventional method;

FIG. 3 is an image display illustrating searching in which a user hierarchically constructs his or her own fields of interest into a filter vector so that only the filtered search results are shown to the user;

FIG. 4 is a flowchart illustrating a mobile information retrieval method according to an embodiment of the present invention;

FIG. 5 is a flowchart illustrating a mobile information retrieval method using a query cache according to an embodiment of the present invention;

FIG. 6 is a flowchart illustrating a mobile information retrieval method using a query cache according to an embodiment of the present invention;

FIG. 7 is a flowchart illustrating a content information clustering method according to an embodiment of the present invention;

FIG. 8 is a flowchart illustrating a content information clustering method based on similarity according to an embodiment of the present invention;

FIG. 9 is an image illustrating how to retrieve and cluster information using a mobile terminal according to an embodiment of the present invention;

FIG. 10 is a diagram illustrating a structure of a mobile information retrieval system according to an embodiment of the present invention; and

FIG. 11 is a diagram illustrating a structure of a mobile information retrieval system according to an embodiment of the present invention.

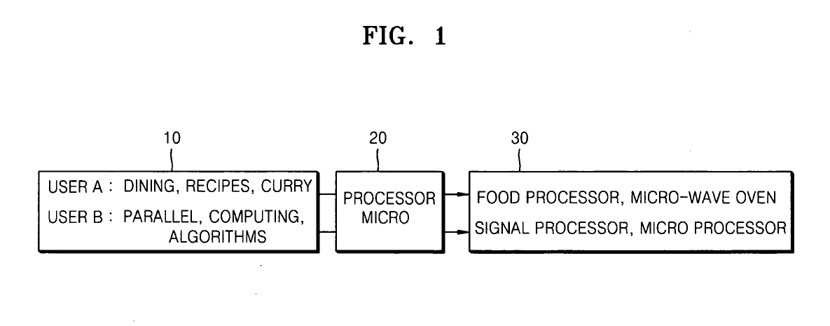

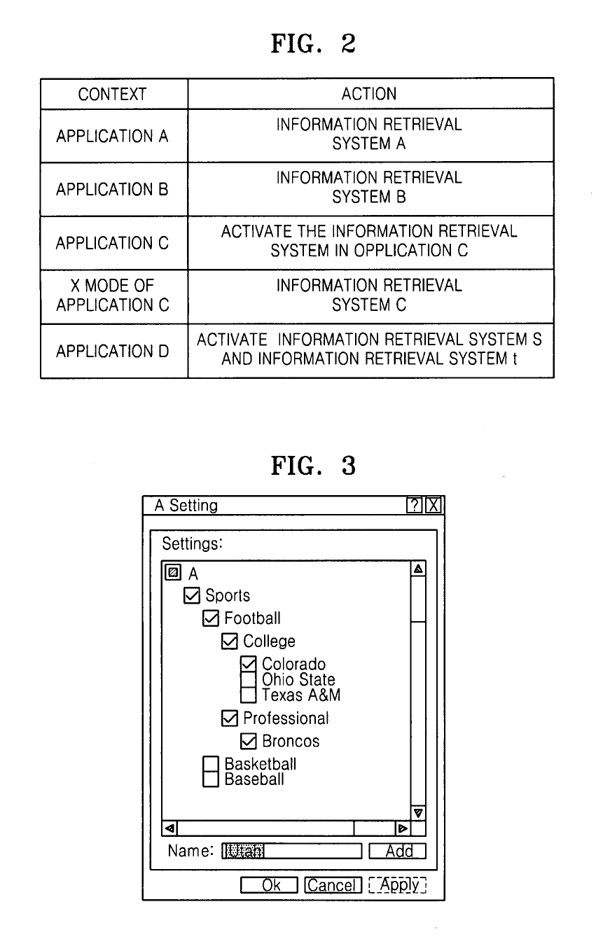

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

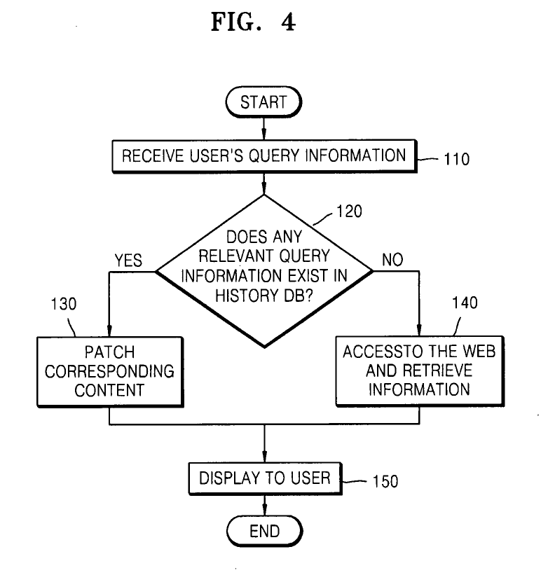

FIG. 4 is a flowchart illustrating a mobile information retrieval method according to an embodiment of the present invention.

As shown in FIG. 4, the mobile information retrieval method according to an embodiment of the present invention comprises receiving a user's query information in operation 110 by a mobile terminal (not shown), determining whether any history information that is relevant to the user's query information exists in a history database (DB) in operation 120, and patching the corresponding content when similar query information is found in operation 130, or accessing the web and retrieving information when similar query is not found in operation 140.

First, in operation 110, the mobile terminal receives the user's query information through a query input unit. The mobile terminal receives the query information in a literal form through input key control or in a phonetic form when the mobile terminal provides a speech recognition function.

The mobile terminal according to an embodiment is a communication system or device which enables information retrieval in a moving environment such as that experienced by a cellular phone, a PCS, a PDA, a laptop, etc., whereby a database of history information related to previous search history is constructed. History information refers to information related to search history which is previously generated and downloaded on the mobile terminal by information retrieval on networks. Examples of history information include content information which is downloaded on the mobile terminal through web searching and user's query information which is used in retrieving the content information. The mobile terminal according to an embodiment of the present invention, indexes the content information with the query information or matches and stores the content and query information to patch the content information afterwards.

According to an embodiment of the present invention, the history information further comprises link information used in retrieving content. The information on the content information is a text information which is extracted from web content in web page format, a text information which is extracted from web content in text format, or metadata which is extracted from web content.

From operation 110, the process moves to operation 120, where the mobile terminal determines whether any information relevant to the user's query information received in operation 110 exists in the database containing the history information. The mobile terminal determines whether any information relevant to the query information exists among the history information that has been generated by previous retrievals prior to information retrieving on networks. According to an embodiment of the present invention, the relevant information in the current operation comprises any query information that is similar to the received query information, or any query information corresponding to the similar query information. The information related to the query information is also obtainable through information retrieval based on the substance of the content in the history database. However, it is necessary to retrieve information that is similar to the received query information among the query information and link information that have been previously used and stored prior to the information retrieval based on the substance of the content.

From operation 120, the process moves to operation 130, where the mobile terminal patches the content information according to the query information found in operation 120 when the query information is found in.

From operation 130, the process moves to operation 140, where the mobile terminal accesses the web and performs information retrieval when no relevant query information is found in operation 120.

From operation 140, the process moves to operation 150, where the mobile terminal provides a final product, which is, content information or retrieval lists obtained from the operations 130 and 140.

There are several advantages of present invention. For example, various embodiments of the present invention take into consideration the distinctiveness of mobile information retrieval means. Mobile information retrieval has small population of users and is characteristic in that information which is in instant need and reflects the user's interests and inclination such as weather information, movie information, stock price information, music information, posting on in communities, e-mail, Internet banking, etc. is mostly retrieved and thus there is high probability to repeat the similar retrievals. Embodiments of the present invention take into consideration of the high probability that a query used in previous information retrieval can be re-used and previously retrieved content can be repeatedly retrieved, stores the query information used in retrieving the content information as history information in the mobile terminal, and use them for information retrieval afterwards. The present invention can relieve inconveniences such as limits in display screen and battery capacity and charges for mobile web access.

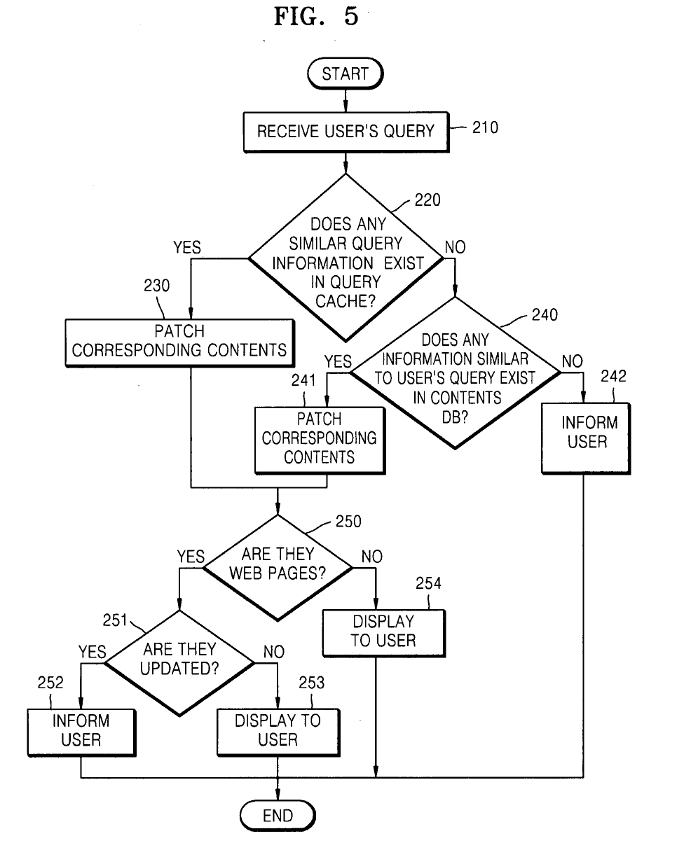

FIG. 5 is a flowchart illustrating a mobile information retrieval method according to another embodiment of the present invention.

In operation 210, the mobile terminal receives the user's query information.

From operation 210, the process moves to operation 220, where the mobile terminal determines whether any query information that is similar to the user's query information exists in a query cache. The mobile terminal can incorporate the query cache using a cache memory which is a physical means, or using software. The query cache of the current embodiment comprises the history database with a content database. According to an embodiment of the present invention, a link cache(not shown) may be used with or as an alternative of the query cache.

In operation 210, the mobile terminal determines a similarity between the user's query information and the query information stored in the query cache, by changing each of the user's query information and the query information stored in the query cache into spatial vector, calculating the similarity using the distance or angle between the spatial vectors, and comparing the calculated value of similarity to a predetermined similarity threshold.

The determination of similarity is performed by using various models that can be applied to calculation of the similarity between a query and a document. Examples of those models comprise a vector space model, a probabilistic model, an extended Boolean model, a knowledge base model, for example. Using these models, the value of similarity between the user's query information and the query information stored in the query cache is calculated, and whether the value of similarity is higher than the predetermined similarity threshold is determined, and thus, the query information similar to the user's query information can be retrieved.

Examples of the vector space models for calculating similarity include a cosine coefficient model (see Equation 1), a Euclidean distance model (see Equation 2), an inner product model (see Equation 3), for example.

$$\begin{matrix}sim ( {d}_{i} , {d}_{j} ) = \frac{{\sum }_{k = 1}^{n} {w}_{ik} \cdot {w}_{jk}}{\sqrt{{\sum }_{k = 1}^{n} {w}_{ik}^{2} \cdot {\sum }_{k = 1}^{n} {w}_{jk}^{2}}} \\ {d}_{i} = ( {w}_{i 1} , {w}_{i 2} , … , {w}_{in} ) \\ {d}_{j} = ( {w}_{j 1} , {w}_{j 2} , … , {w}_{jn} ) & [ Equation 1 ] \\ sim ( {d}_{i} , {d}_{j} ) = {\sum }_{k = 1}^{n} {w}_{ik} \cdot {w}_{jk} & [ Equation 2 ] \\ dist ( {d}_{i} , {d}_{j} ) = \sqrt{{\sum }_{k = 1}^{n} {( {w}_{ik} - {w}_{jk} )}^{2}} & [ Equation 3 ]\end{matrix}$$

where dᵢ, and dⱼ are vectors having information for similarity determination weighted. For example, dᵢ is a vector (wᵢ₁, wᵢ₂, . . . wᵢₙ) having the query information weighted, and dⱼ is a vector (wⱼ₁,wⱼ₂, . . . wⱼₙ) having the history information weighted. Similarity can be determined after extending the query to analogous fields using a synonym set.

When it is determined that similar query information exists in the query cache in operation 220, the process moves to operation 230 where the mobile terminal patches the content information corresponding to the similar query information.

In operation 240, the mobile terminal searches for content information which is similar to the user's query in the content information database when no similar query information exists in the query cache. The above models used in calculating the similarity between a query and a document can be used to determine the similarity between the content information and the query information.

In operation 240, when similar content information is found in the content information database, the mobile terminal patches the content (in operation 241). When similar content information is not found, the mobile terminal informs the user (in operation 242).

From operation 241, the process moves to operation 250, where the mobile terminal determines whether the content information read from the operations 230 and 240 includes web pages. When the content is web pages, the mobile terminal determines whether they are updated or not (in operation 251). When the web pages are updated, the mobile terminal informs the user (in operation 252). When the web pages are not updated, the mobile terminal shows (in operation 253) the content information read from the operations 230 and 240. When the content information read from the operations 230 and 240 does not include web pages but instead, includes text files, for example, the mobile terminal displays the content to the user (see operation 254).

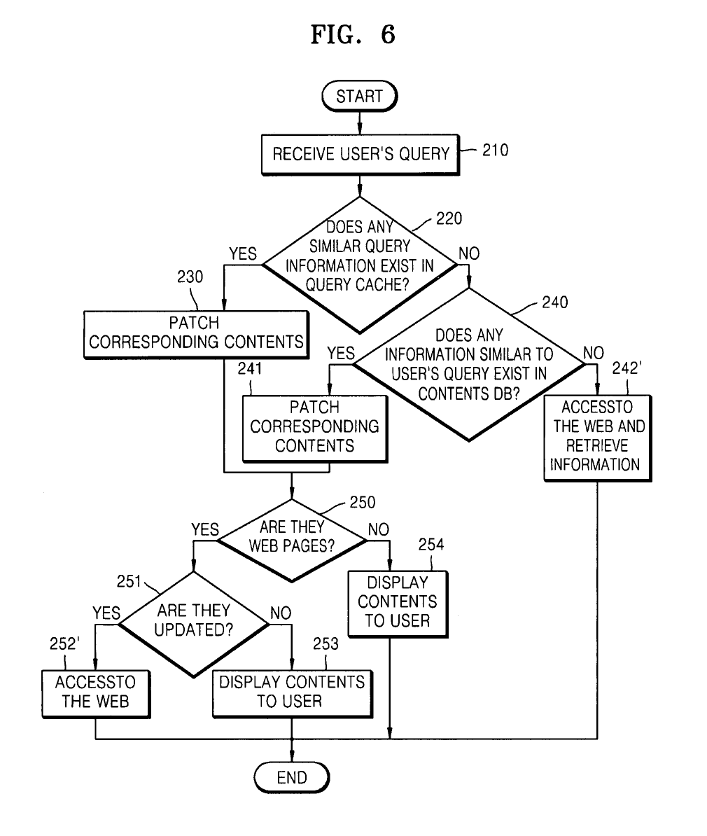

FIG. 6 is a flowchart illustrating a mobile information retrieval method using a query cache according to another embodiment of the present invention. FIG. 6 differs from FIG. 5 in that web access is introduced as a way of information retrieval.

In this embodiment of the present invention, the mobile terminal accesses the web and performs information retrieval (in operation 242′) when it determines no content information similar to the query information exists in the content database in the operation 240. Also, when it is determined that the web pages are updated in operation 251, the mobile terminal accesses the web pages (in operation 252′) and provides the accessed web pages to the user. The same method as described in FIG. 5 is used to retrieve information except the operations 242′ and 252′.

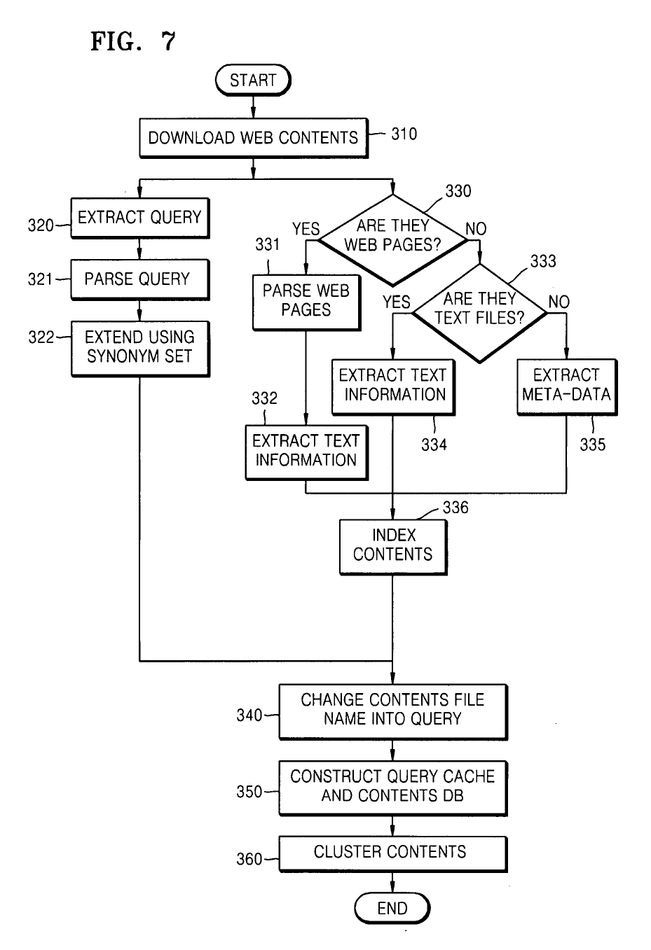

FIG. 7 is a flowchart illustrating a content information clustering method according to an embodiment of the present invention. This embodiment relates to a content information clustering method based on the query information generated by the content information retrieval.

The mobile terminal downloads at least one web content in operation 310, extracts, parses, and extends the query information in operations 320-322, and indexes the content in operations 330-336.

In operation 320, the mobile terminal extracts the query information at the same time of or right after downloading the web content. The mobile terminal can extract the query information when a web client makes a request to a web server in the GET/POST method. An example of obtaining the query information from Base64-encoded URL is described below. When a query “World Cup schedule” is entered into the Naver search box, the URL is as below.
URL: http://search.naver.com/search.naver?where=nexearch&query=%BF%F9%B5%E5%C4%C5+%BD%C3%B0%A3%C7%A5&frm=t1&sm=top_hty
Action: http://search.naver.com/search.naver
Parameter type: name=value pairs
select type: where=nexearch
input type: query=% BF%F9%B5%E5%C4%C5+%BD%C3%B0%A3%C7%A5
Base64-encoded string of “World Cup schedule”
hidden input type: form=t1
hidden input type: sm=top_hty

In the example, the mobile terminal can obtain the query information that is encoded in “BF%F9%B5%E5%C4%C5+%BD%C3%B0%A3%C7%A5”, when the web client makes a request to the web server in the GET method.

In operation 321, the mobile terminal parses the query information. Query parsing means deleting stop words such as prepositions, articles, etc., which do not directly affect the meaning of the query, using linguistic analysis.

In operation 322, the mobile terminal extends the keywords extracted from the query using a synonym set. For example, the mobile terminal can extend the query keyword [World Cup match schedule] to [World Cup match tournament schedule program table] through a synonym extension process.

Although not shown in FIG. 7, alternatively, the mobile terminal according to an embodiment of the present invention further extracts link information instead of or in addition to the query information. When the link of the content is “http://i-soccer.hani.co.kr/arti/sports/soccer/worldcup2006,” the mobile terminal can extract the link information when downloading the content, and can extract i-soccer, hani, arti, sports, soccer, worldcup2006, etc. through link parsing. Further, the mobile terminal can automatically cluster web content by distinguishing Internet addresses from routes of information when parsing links. In the above example, “i-soccer.hani.co.kr” that is an Internet address indicates the information provider, and “arti/sports/soccer/worldcup2006” indicates a route of the information.

In operation 330, the mobile terminal determines whether the web content information includes web pages. When the web content information is determined to be web pages, the mobile terminal parses the web pages (in operation 331) and extracts text information (in operation 332). When it is not web pages, whether the web content information is text files or not is determined (in operation 333), and text information is extracted (in operation 334) when the web content information is text files, or metadata is extracted (in operation 335) when it is not text files. The mobile terminal indexes the web content (in operation 336) using the information extracted from the operations 332, 334 and 335.

In operation 340, the mobile terminal changes the file name of the content into the query used in retrieving the content, so that information retrieval becomes easier afterwards by changing the file name to the query information used in retrieving the content.

In operation 350, the mobile terminal constructs the query cache using the query information obtained from the operation 322, and builds the content DB from the web content files of which names are changed in the operation 340.

In operation 360, the mobile terminal automatically clusters the web content using the extracted information. According to an embodiment of the present invention, the mobile terminal clusters the web content based on the similarity of the extracted query information. Prior to clustering in operation 360, the mobile terminal calculates the similarity between the query information which is extracted from the content information to be clustered and the query information which is already clustered and stored, or between each query information extracted from each content information to be clustered, and classify the content based on the calculated similarity in a high-to-low order. The keywords related to the query which are previously used to retrieve the corresponding content represent the content best in the user's view, thus information clustering according to the user's inclination is attainable using the keywords.

Although not shown in FIG. 7, alternatively, the mobile terminal according to an embodiment clusters web content using the link information instead of the query information. The link information for clustering the web content includes the link information related to the subjects of the content and the link information about the routes.

Examples of extracting the link related to the subjects of the content are as below. In http://www.etnews.co.kr/news/detail.html?id=200607110146, the subject of the content is “etnews” and the subject of the content is “naver café” in http://cafe.naver.com/coffeemaru.cafe?iframe_url=/ArticleRead.nhn%3Farticleid=2212. The mobile terminal can cluster the web content into “etnews” articles and content downloaded from “naver café” using the information about the subjects extracted from the links. Meanwhile, since a route extracted from link information is a kind of clustering information which is provided by the corresponding site, the mobile terminal can use the extracted route as information on similarity between contents by calculating how much the route-information is shared by the contents.

Information related to the subject of the content and information related to the route extracted from the link information are conceptually separate from each other, and thus similarity can be calculated independently using each of them. Regarding to a content having http://i-soccer.hani.co.kr/arti/sports/soccer/worldcup2006 as the link information for example, the mobile terminal can distinguish it into a “hani” class and a “World Cup” class and cluster the content information by independently determining similarity. Since those keywords related to the link information are clustering information which the website providing the web content already used for clustering the content, the content can be clustered more effectively using the link information.

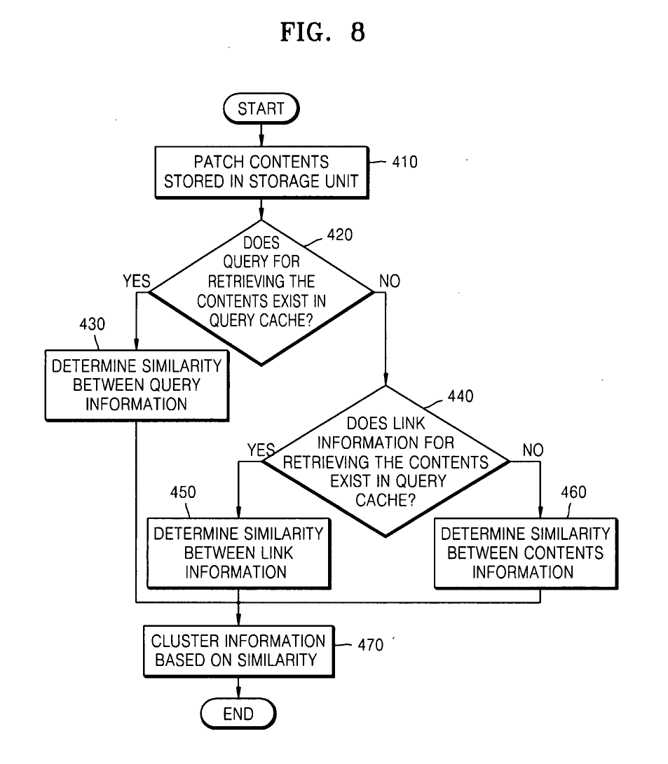

FIG. 8 is a flowchart illustrating a content information clustering method based on similarity according to an embodiment of the present invention, and illustrates a content information clustering method of a mobile terminal, which automatically clusters content information by calculating the similarity between a query, a link, and content.

In operation 410, the mobile terminal patches at least one content information to be clustered from the content database. The content information of this operation includes not just the content information which is downloaded on the mobile terminal but also content information which is downloaded from personal computers or movable storage media.

In operation 420, the mobile terminal determines whether the query information for retrieving the content exists in the query cache. The mobile terminal according to this embodiment deals with both the query information and the link information used in retrieving the content information in a query cache form.

In operation 430, when query information for retrieving content exists in the query cache, the mobile terminal calculates the similarity between the query information.

In operation 440, the mobile terminal determines whether any link information of content information exists in the query cache when no query information for retrieving content exists in the query cache.

In operation 450, the mobile terminal calculates the similarity between the link information when the link information exists in the query cache. The link information can be divided into information on the content provider and information for clustering, and the similarity can be calculated separately.

In operation 460, the mobile terminal calculates the similarity between contents when no link information exists in the query cache. The similarity can be calculated using the various models used in calculating the similarity between a query and a document as described in FIG. 5.

In operation 470, the mobile terminal clusters the documents based on the similarity using the results of the operations 430, 450 and 460. The similarity calculation for automatically clustering the content Cᵢ and Cⱼ for example, is as below. α, β, and χ of Equation 4 are weighting values on each value of similarity.

Sim(Cᵢ,Cⱼ)=α*SimQuery(Cᵢ ,Cⱼ)+β*SimLink(Cᵢ,Cⱼ)+χ*SimContent(Cᵢ,Cⱼ) [Equation4]

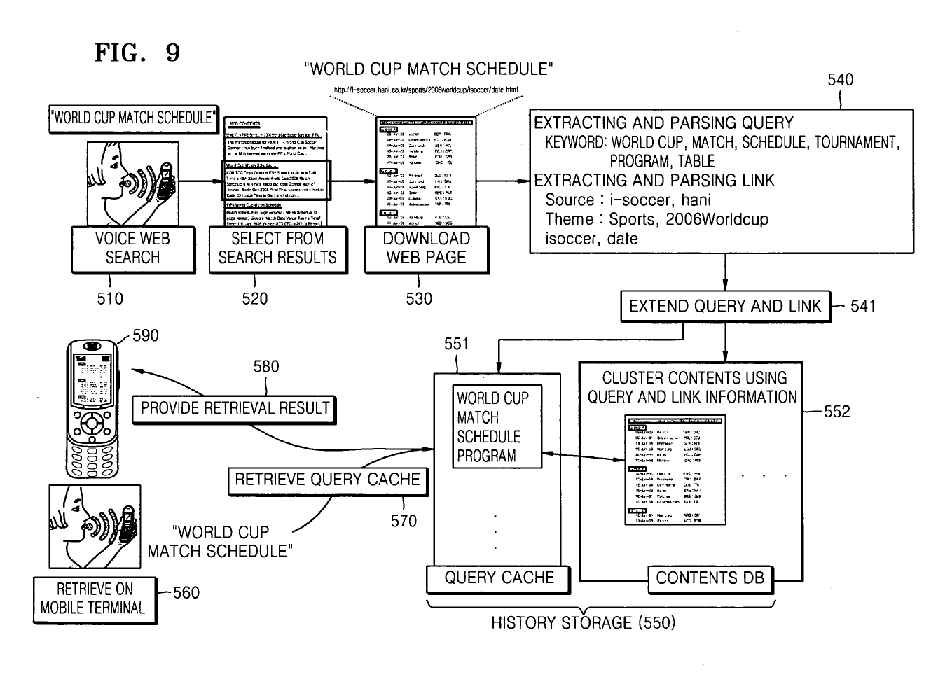

FIG. 9 illustrates how to retrieve and cluster information using a mobile terminal according to embodiments of the present invention.

When the mobile terminal which provides a voice web search service (in operation 510) receives the user's query information, “World Cup match schedule,” the results of information retrieval are displayed on the screen of the mobile terminal and one of the results is selected (in operation 520).

The mobile terminal downloads web pages related to World Cup match schedule (in operation 530). The query information and the link information used in retrieving the web page information are separately extracted and parsed (in operation 540). The keywords of the parsed query information and link information are extended to analogous extent using a synonym set (in operation 541).

The web content, query and link information obtained from the above process are stored in a history information storage unit 550 in the mobile terminal. The history information storage unit comprises a query cache 551 and a content database (DB) 552. The web content information is stored in the content DB 552 according to the query and link information, and the query and link information is stored in the query cache 551. The query and link information and the content DB corresponding to the query and link information are matched and stored.

It is difficult to remember which information is stored in the mobile terminal when various kinds of content information are stored in the mobile terminal. When the user wants to get information related to “World Cup match schedule” again, the user inputs a query when not certain whether the content information related to the query is stored in the mobile terminal. When the user inputs a query such as “World Cup match program” in an information retrieval menu in the mobile terminal (560), firstly the query or link information that is similar to the input query is searched (570) in the query cache 551, then the content information corresponding to the similar query or link information is patched from the content database and provided to the mobile terminal (operations 580 and 590) The web information retrieval method in an unaccessed state according to the current embodiment can relieve a battery problem due to web access, a display problem, and an expensive charge problem due to web access.

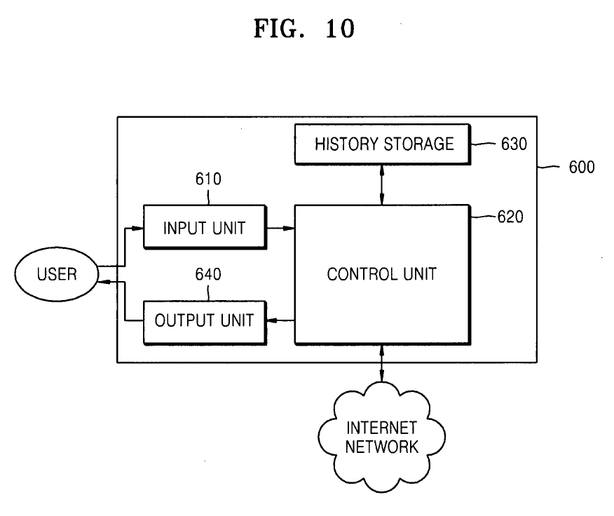

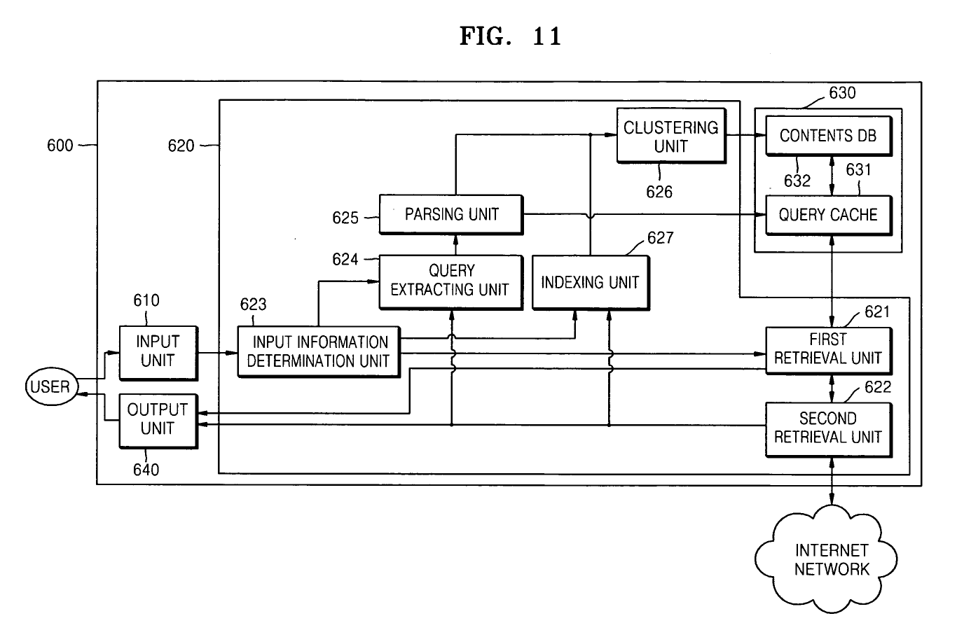

FIG. 10 illustrates a mobile information retrieval system according to embodiments of the present invention.

A mobile information retrieval system 600 according to an embodiment of the present invention comprises an input unit 610, a control unit 620, a history information storage unit 630, and an output unit 640.

The input unit 610 receives the user's query information for retrieving information. The input unit 610 comprises input keys of mobile terminals or microphones of mobile terminals that support voice recognition.

The control unit 620 processes information according to the input information received from the input unit. Specifically, the control unit 620 retrieves information related to the received query information in the history information storage unit, and selectively accesses networks to retrieve information depending on the retrieved results.

The history information storage unit 630 stores the information generated by previous information retrieval through predetermined networks, and examples of the information includes the content information downloaded on the mobile terminal, the query and link information used in retrieving the content information.

The output unit 640 provides the user with the information resulted from the information retrieval by the control unit 620.

FIG. 11 is a diagram illustrates a structure of mobile information retrieval system according to an embodiment of the present invention.

FIG. 11 is a more detailed version of the mobile information retrieval system shown in FIG. 10. The mobile information retrieval system 600 according to the current embodiment of the present invention, comprises the control unit 620 comprising a first retrieval unit 621, a second retrieval unit 622, an input information determination unit 623, a query extracting unit 624, a parsing unit 625, a clustering unit 626, and an indexing unit 627, and the history information storage unit 630 comprising a query cache 631 and a content database 632.

The first retrieval unit 621 performs retrieving any information similar to the query information received from the input unit 610 in the history information storage unit 630. When the first retrieval unit 621 finds similar history information in the query cache 631, the first retrieval unit 621 reads the content information related to the similar history information from the history information storage unit 632, and provides it to the user by means of the output unit 640.

If no similar information is found in the history information storage unit 630, the first retrieval unit 621 sends an information retrieval request signal to the second retrieval unit 622 that performs information retrieval through networks, and the second retrieval unit 622 performs information retrieval on the Internet according to the request and transmits the results to the first retrieval unit 621 or directly provides it to the user by means of the output unit 640.

The input information determination unit 623 determines whether the information received from the input unit 610 comprises a request for information retrieval or for storing the content information resulted from the information retrieval in the mobile terminal. When the information received from the input unit 610 is a request for information retrieval, the input information determination unit 623 sends an information retrieval command to the first retrieval unit 621 and the second retrieval unit 622. When the information received from the input unit 610 is of request for storing the content information resulted from the information retrieval in the mobile terminal, the input information determination unit 623 makes a request for extracting the query used in retrieving the web content information to the extracting unit 624, and makes a request for indexing the web content to the indexing unit 627.

The extracting unit 624 extracts the query information and the link information when downloading the web content from the second retrieval unit in response to the request from the input information determination unit, and an example of extraction is already described.

The parsing unit 625 parses the extracted query and link information in response to the request from the input information determination unit. The parsing unit deletes stop words such as prepositions, which do not directly affect the meaning of query, using linguistic analysis. Although not shown in FIG. 11, the system 600, according to an embodiment of the present invention, comprises an extending unit included between the parsing unit 625 and the clustering unit 626, which extends the query using a synonym set.

The clustering unit 626 clusters the web content in consideration of the similarity among the query information, link information and the content information. The clustering methods using the value of similarity are explained above.

The indexing unit 627 indexes the web content sent from the second retrieval unit when it receives a request for indexing from the input information determination unit 623. For example, the indexing unit 627 indexes the web content using text information or metadata extracted from the web content, or using the query information and link information.

In conventional methods, indexing and retrieval are performed mainly based on the content. However, in the method according to the current embodiment of the present invention, the history information such as the query information and link information is used in indexing and retrieving the content, and thus, effective and user-specific information retrieval and clustering can be achieved.

The history information storage unit 630 according to an embodiment of the present invention, comprises the query cache 631 where the query information or link information is stored and the content DB where the content information is stored. Using the query information or link information stored in the query cache when retrieving and clustering information is not effective in mobile terminals of which computing resource is limited.

Although not shown in the drawings, according to another embodiment of the present invention, there is provided a computer-readable recording medium on which a program for executing the mobile information retrieval or clustering method in a computer is recorded.

Examples of the recording medium that can be read by computers include ROMs, RAMs, CD-ROMs, magnetic tapes, floppy discs, optical data storage devices, etc. and embodiments in the form of carrier wave, transmission through the Internet for example, can also be included.

Programs, codes and code segments which can perform each function for operating the recording medium can be easily thought by programmers in the related art of the present invention.

According to embodiments of the present invention, the query information, link information, for example, which are generated by previous information retrieval are stored as the history information and made use of in mobile information retrieval afterwards, unlike the conventional methods which basically require web access. Therefore, electric consumption due to web access can be reduced, inconvenience resulted from limits in display screen and computing resource can be relieved as well as charges for web access.

In addition, faster and user-specific information retrieval is attainable by retrieving information based on the query information, and link information which take relatively small volume and reflect the user's inclination in information retrieval compared to retrieving information based on the content information.

The content information clustering methods according to embodiments of the present invention, for example, make use of the history information related to information retrieval and thus enable user-friendly logical information clustering. The mobile information retrieval based on the clustered information helps the user find the information the user wants faster and more precisely.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A mobile information retrieval method comprising:
receiving a user's query information; and
retrieving information related to the received query information from a database in which history information generated by previous retrieval using predetermined networks is stored.

2. The method of claim 1, wherein the information related to the received query information is information of which similarity to the received query information is greater than a predetermined similarity threshold.

3. The method of claim 1, wherein the history information comprises content information which is downloaded on a mobile terminal by retrieving information previously prior to receiving the user's query information, and further comprises at least one of query information, link information and information on the content information which are used in retrieving the content information.

4. The method of claim 1, further comprising selectively accessing the networks depending on the result of retrieving information related to the received query information from a database in which history information generated by previous retrieval using the predetermined networks is stored, and providing information related to the received query information to the user.

5. The method of claim 1, further comprising:
changing each of the received query information and history information into a spatial vector, and comparing a distance or angle between the spatial vector of query information and the spatial vector of history information to the distance or angle corresponding to a predetermined similarity threshold,
wherein the retrieving information related to the received query information from a database in which history information generated by previous retrieval using the predetermined networks is stored further comprises retrieving information which is related to the received query information based on the result of comparing.

6. The method of claim 3, further comprising storing the query information, link information or content information used in retrieving the content information in a cache form.

7. The method of claim 3, wherein the information on the content information comprises text information which is extracted from web content in web page format, a text information which is extracted from web content in text format, or metadata which is extracted from web content.

8. A computer readable medium implementing a mobile information retrieval method to be performed by a computer, the method comprising:
receiving a user's query information; and
retrieving information related to the received query information from a database in which history information generated by previous retrieval using a predetermined networks is stored.

9. A content information clustering method comprising:
extracting information related to retrieval of at least one content information that is retrieved through a predetermined network; and
clustering the content information using the extracted information.

10. The content information clustering method of claim 9, wherein the information related to retrieval of content information comprises at least one of the query information, link information and information on the content information which are used in retrieving the content information.

11. The content information clustering method of claim 9, further comprising:
parsing the information extracted,
wherein the clustering of the content information using the extracted information comprises clustering the content information based on a result of parsing.

12. The content information clustering method of claim 9, further comprising: calculating similarity between information independently extracted from the at least one content information,
wherein the clustering of the content information using the extracted information comprises clustering together content information having higher similarity than a predetermined similarity threshold.

13. The content information clustering method of claim 11, further comprising deleting stop words which do not affect a meaning of the information extracted based on the result of parsing,
wherein the clustering of the content information using the extracted information comprises clustering using the information from which the stop words are deleted.

14. A computer readable medium on implementing a content information clustering method by a computer, the method comprising:
extracting information related to retrieval of at least one content information that is retrieved through a predetermined network; and
clustering the content information using the extracted information.

15. A mobile information retrieval system comprising:
a history information storage unit which stores history information comprising information generated by previous information retrieval through predetermined networks;
an input unit which receives a user's query information;
a control unit which retrieves information related to the query information in the history information storage unit, and selectively accesses the predetermined networks to retrieve information related to the query information; and
an output unit which provides the information retrieved by the control unit.

16. The mobile information retrieval system of claim 15, wherein the control unit retrieves information related to the query information by determining the similarity between the query information and the history information.

17. The mobile information retrieval system of claim 15, wherein the control unit comprises:
a first retrieval unit which retrieves information related to the query information in a database of the storage unit;
a second retrieval unit which retrieves information related to the query information through predetermined networks when the first retrieval unit finds no information related to the query information.

18. The mobile information retrieval system of claim 15, wherein the control unit further comprises:
an extracting unit which extracts the query information or link information used in retrieving the content information when downloading the content information which is retrieved by accessing to the networks;
a clustering unit which clusters the content information using the information extracted in the extracting unit; and
an indexing unit which indexes the content information,

19. The mobile information retrieval system of claim 15, wherein the history information storage unit comprises:
a first storage unit which stores the content information retrieved through the networks; and
a second storage unit which stores the query or link information used in retrieving the content information.
